(19) United States
(12) Patent Application Publication
(10) Pub. No.: US 2011/0150136 A1
(43) Pub. Date: Jun. 23, 2011

(54) DUTY CYCLE COMPENSATING DIGITAL DATA RECEIVER

(75) Inventor: Roger A. Bethard, Chippewa Falls, WI (US)

(73) Assignee: Cray Inc., Seattle, WA (US)

(21) Appl. No.: 12/643,532

(22) Filed: Dec. 21, 2009

(51) Int. Cl. H04L 27/00

(52) U.S. Cl. 375/316

(57) ABSTRACT

A data communication receiver includes an interface operable to receive at least one incoming data signal. A transition point tracker is operable to track data transition points of the data signal, and a data sampler is operable to sample the data signal at a desired sampling point between transition points.

### FIELD

The invention relates generally to electronic communications, and more specifically to a duty cycle compensating digital data receiver.

### BACKGROUND

When digital signals are transmitted across electrical connections, the impedances and other characteristics of the electrical connections have an effect on the signal. Conductors are imperfect to varying degrees, and the transmitted power must be of sufficient to result in an adequate signal-to-noise ratio where the signal is received.

Although digital signals are typically considered to have one of two voltage levels and to travel instantaneously, in reality this is an ideal that is not physically possible to achieve. Digital signals must transition from one voltage to another over a period of time, which is dependent on the circuitry creating the signal and on the device or wire that is being driven. Also, various conductor or driven device characteristics can sometimes result in a digital signal's voltage overshooting its intended target voltage or to oscillate slightly about the intended voltage.

Because the transition from one voltage level to another can take a period of time that is influenced by other circuit factors, it is sometimes difficult to specify exactly when a digital signal's voltage level will cross a threshold point and be considered to be at one signal level or another, especially if the signal is distributed to multiple points in a circuit. Variations in timing occur, even in relatively stable digital circuits such as digital clock signal circuits.

For these and other reasons, design of high-speed communications channels such as serial channels linking various integrated circuits in an electronic device such as a high performance computer must take into account the various factors that can cause imperfections in the serial communications channel data, or within the system clock data. A variety of factors, such as delay or skew, altered clock duty cycle, or altered data signal duty cycle can contribute to misreading such data.

It is therefore desired to manage communication of serial data within a communications channel to manage such factors.

### SUMMARY

One example embodiment of the invention comprises a data communication receiver, including an interface operable to receive at least one incoming data signal. A transition point tracker is operable to track data transition points of the data signal, and a data sampler is operable to sample the data signal at a desired sampling point between transition points.

### BRIEF DESCRIPTION OF THE FIGURES

FIG. 1 shows a clock and accompanying data signals, consistent with the prior art.

FIG. 2 shows a narrow clock and accompanying data signals having corresponding narrow periods, consistent with an example embodiment of the invention.

FIG. 3 shows a wide clock and accompanying data signals having corresponding wide periods, consistent with an example embodiment of the invention.

FIG. 4 shows a clock and accompanying data signals having narrow high signal periods, consistent with an example embodiment of the invention.

FIG. 5 shows a clock and accompanying data signals having narrow low signal periods, consistent with an example embodiment of the invention.

FIG. 6 shows a clock and accompanying data signals sampled based on observed transition points, consistent with an example embodiment of the invention.

FIG. 7 shows ideal bandwidth-limited data signals, consistent with an example embodiment of the invention.

FIG. 8 shows a data signal eye pattern, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Communications channels such as serial channels driven by serializer/deserializer (SerDes) interfaces typically use a data signal path to send and receive data between devices, such as multiple integrated circuits in a digital logic system, and a system clock signal distributed between the integrated circuits. High-performance computers, for example, often rely on high speed serial communications channels to link various components, such as processors, memory controllers, network circuits, etc.

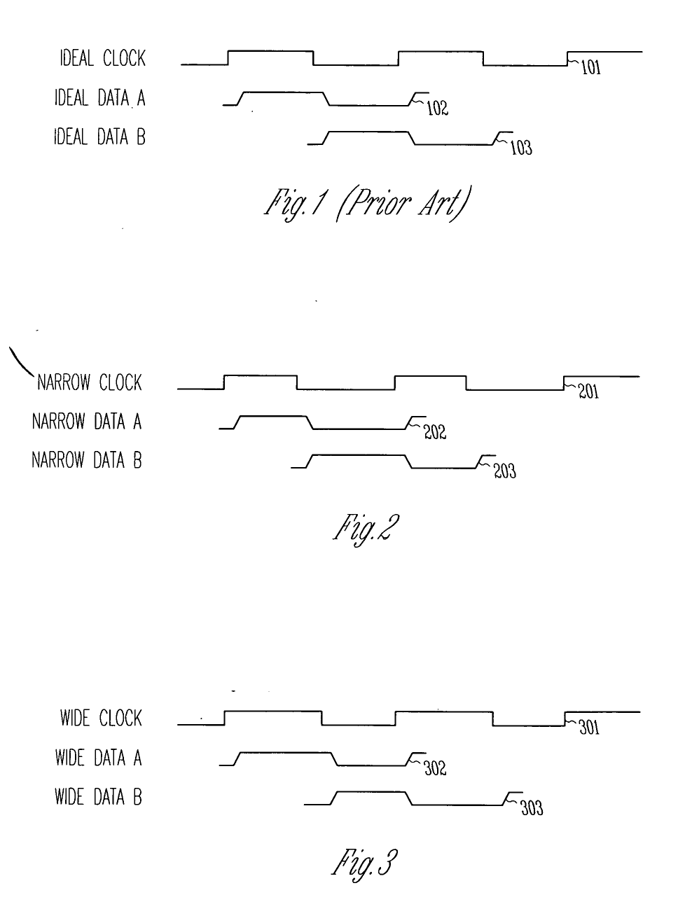

But, as performance of these communications channels is pushed to the limits of channel performance, factors such as noise, jitter, capacitive coupling, skew, and other physical factors make the data and clock signals imperfect. FIG. 1 illustrates an ideal clock signal and associated data channels, consistent with the prior art. Here, an ideal clock 101 transitions between a high and a low signal level, with instantaneous transitions between state and equal time spent in high and low states. Data signal A, shown at 102, also has equal high and low signal level periods, and the transitions between high and low occur at uniform times only very slightly after the clock transition.

The data signal B shown at 103 also has equal high and low signal level periods, and transitions occur at a uniform time after clock transitions. Moreover, transitions for data signal A and B occur at the same time, irrespective of whether the transitions are rising or falling data, or occur at the rising or falling edge of a clock signal.

But, such perfect clock and timing signals are often not achievable in real-world systems running near their performance limits. FIG. 2 illustrates an example of an imperfect clock and data signals in which a clock signal having a narrow duty cycle results in data having alternating narrow and wide symbols. At 201, the clock signal can be seen to have shorter high signal level periods than low signal level periods, or a duty cycle of less than 50%. The data signals A and B both transition a uniform period after each clock transition, and therefore also have alternating short and long periods as shown at 202 and 203. In the example waveforms shown, data signal A has a narrower high signal level than a low signal level, in proportion to the clock's deviation from an even 50% split between high and low states. Similarly, signal B has a wider high than low signal level, as the high signal level occurs during a longer, low portion of the clock while signal B's low signal level occurs during a narrower high clock state.

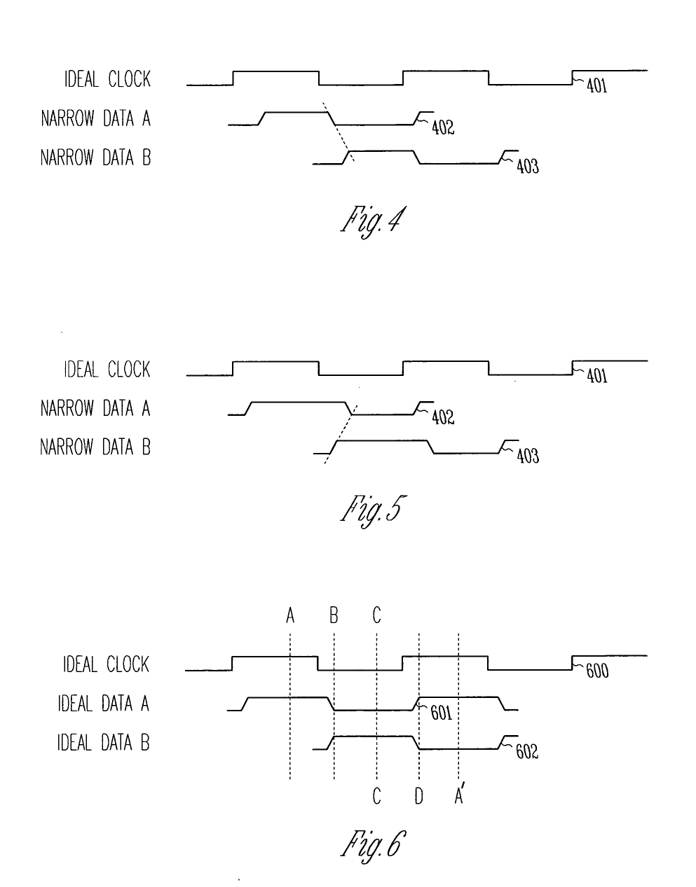

The opposite effect can be observed in FIG. 3, which shows a clock signal having a duty cycle greater than 50%, and the resulting data signals. Here, the clock signal 301 has significantly longer periods of high signal level than periods spent at low signal level, and the resulting data signals A and B derived from clocked logic have transition points that are shifted, corresponding to the shifted clock transition points as a result. Data signal A, shown at 302, has a significantly longer high period than low period in the signal shown, as the signal's high period corresponds to a longer high clock level and the signal's low period corresponds to a relatively short clock low signal level.

In other circuit examples, the data is not skewed as a result of a clock having a duty cycle that deviates from 50%, but the data signal itself varies from the clock. FIG. 4 shows such a timing diagram, illustrating a clock signal along with narrow data signals. Here, the clock 401 is symmetric, but the data signal 402 is skewed such that low signal level periods extend longer than high signal level periods. Similarly, data signal 403 shows low signal level periods extending longer than high signal level periods, irrespective of whether the low signal or high signal level periods occur on a high or low clock period. Such a phenomenon can be observed in circuits where the data signal conductors capacitively couple to ground, or due to other such parasitic impedance or other effects.

Similarly, FIG. 5 shows a clock having a 50% symmetric duty cycle, but data signals having extended high state periods. Here, the clock 501 is symmetric as in the example of FIG. 4. The data signal 502 has a high period that is extended and a low period that is short relative to the clock signal periods. The data signal 503 also has an extended high signal level period and a shortened low signal level period, but is offset half a clock cycle from data signal 502. This illustrates that the extended high signal level periods are not a result of clock signal skew and are not dependent on the clock signal level state, but are dependent on another factor such as capacitive coupling between the data signal lines and a power signal conductor.

These timing problems observed in FIGS. 2-5 illustrate how timing problems, such as duty cycle distortion in clock or data signals, can impact the ability of a deserializer or receiver to accurately read incoming data. For example, an electronic system comprising several integrated circuits such as processors, controllers, application-specific integrated circuits (ASICS) or other such devices often relies on a single distributed clock to time the circuit.

The clock can be distorted due to a wide variety of factors such as parasitic capacitance and inductance of the wires, and distortion can vary throughout a clock tree from device to device. Similarly, the data signal can be distorted as a result of parasitic coupling to power or ground signals, resulting in extended high or low signal level periods.

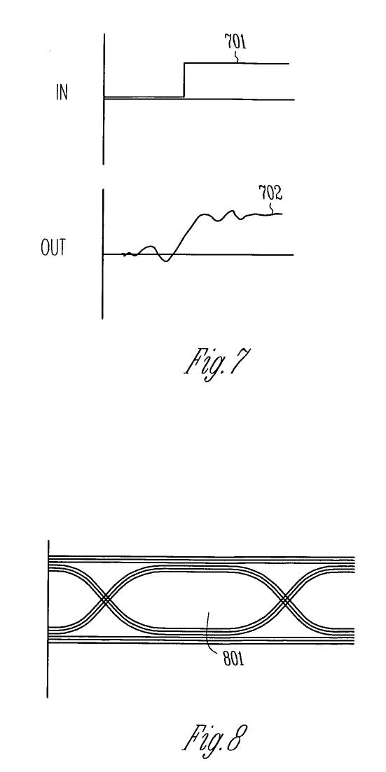

One example embodiment of the invention provides sampling alignment designed to compensate for such effects. FIG. 6 shows a sampling alignment system, consistent with an example embodiment of the invention. Here, a clock signal 600 is shown with data signals 601 and 602. Although the clock signal 600 here has an ideal 50% duty cycle and the data signals do not have timing distortions as observed in FIGS. 2-5, the method described here can be applied to systems in which clock and data signal distortion is present to compensate for such signal distortions.

In this example, sampling during the high clock cycle takes place at time A, and sampling during the low clock cycle takes place at time C. The values read from data signals 601 and 602 at points A and C are recorded as received data, and in a further deserializer example are converted into parallel word data and forwarded. Data signal transition points B and D are also sampled, but the recorded signal level is not forwarded as read data. The B and D samples are used to determine the typical timing of transitions between high and low signal levels, and the observed signal level is used to adjust the timing and position of the B and D sample points.

For example, the location of sample point B in FIG. 6 is shown as occurring at the mid-point of a transition between high and low data signal levels for data signal 601, and a transition between low and high data signal levels for data signal 602. Similarly, the sample point D is located halfway between the transition of signal 601 from low to high and 602 from high to low.

This enables adjustment of the data sampling points A and C based on the effects discussed previously, compensating for narrow or wide data and clock signals by centering data sampling points between movable data transition points based on data signal observation. Asymmetry in the clock or data signal can therefore be compensated by its effect on the observed transition point or points, enabling more accurate reading of the data signal.

It is desired in one embodiment to place the data sample points A and D as near as practical to the center point between state transitions B and D to ensure that the point where the data is read provides the most accurate representation of the data. In other embodiments, an alternate sample point may be chosen, such as two-thirds of the time between transition points, to allow greater signal settling time or for other reasons. In either example, observation of transition points B and D is used to determine sample points A and C.

The position of sample points B and D is here adjusted based on the observed voltage level of data signals, such that the sample points are adjusted to be near the center of the transition based on transition observations. For example, when there is a transition midpoint occurs at point B or D, the timing of the transition point is not altered. If the observed data change midpoint occurs just after a transition point B or D, the transition point is delayed slightly going forward. Similarly, if the observed data change midpoint occurs just before a transition point, the transition point occurs slightly earlier going forward.

A variety of methods can be used to implement such transition point changes, including averaging recent occurrences, using current observations to alter the current transition point a specific amount such as a fraction of the observed difference, or weighted adding of an observed transition point deviation from the system clock to a weighted historical transition point. These and many other methods can make use of transition point observations to move future transition points toward an observed transition point, and are within the scope of the invention.

In an alternate embodiment transition points B and D are not both based on averaged observations, but the earlier transition point is instead based on actual observation. For example, when reading data at point C in the example of FIG. 6, it is desired that sampling point C be located halfway between transition points B and D. In this case, transition point B can be directly observed, as it has already occurred, and so the most recent actual observed transition may be used rather than an averaged or predicted value. As transition point D will not yet have occurred, an averaged or weighted value is used for that transition point in determining sampling point C.

As seen in FIGS. 4-5, transitions from high to low and from low to high do not necessarily occur at the same time relative to the clock, and may occur at different times for different data signals. For example, a data signal line nearer a ground line may be slower to transition from low to high and faster to transition from high to low than a data signal line located near a power signal line, resulting in data signals such as those of FIGS. 4 and 5.

Some embodiments of the invention therefore distinguish between transitions from low to high and from high to low in determining the transition points B and D, such as by determining separate transition points depending on the current high or low state of the data. Others combine the transition point from low to high with the transition point from high to low, so that a single sampling point is used irrespective of the anticipated transition. In another example embodiment, different data lines are each assigned their own sampling circuit, such that the transition and data sampling points are determined separately for each line.

In many of these examples, asymmetry or duty cycle distortion in the data signals or clock signals result in the period from transition point B to transition point D being different than the subsequent period from transition point D to the next transition point B. Use of multiple transition points enables the data receiver to compensate for the duty cycle and other such distortions, enhancing the ability of the receiver to sample the data signal at a desired time to more accurately read the data signal.

Transitions between high and low data signal states often do not resemble ideal data signals with sharp transitions and accurate timing, as is illustrated in FIGS. 1-6. FIG. 7 shows an ideal data signal and a bandwidth-limited data signal, consistent with an example embodiment of the invention. At 701, an ideal data signal transitioning essentially instantaneously from low to high is shown. In practice, signal transitions are always limited by factors such as the parasitic impedances of the conductors carrying the signals, as well as the transistors or other devices used to cause the change in signal state. Although circuit designers try to minimize the effect that these impedances have on signal quality, the circuits are often operated as fast as the circuit's impedance and other characteristics will allow without introducing error.

The result is that data signals often more closely resemble the signal shown at 702, which illustrates a signal transition happening at a speed approaching the bandwidth limit of a circuit. Here, the data signal can be seen to transition more gradually from low to high, limited by the inductance and capacitance of the circuit elements. When the communications channel is being operated near its frequency limit some oscillation can be observed before and after the transition, also shown at 702.

Designers can model the circuit to estimate the effect that this will have on the readability of data, or use other methods such as direct measurement of the circuit to produce data characterizing a particular communications channel. One example of this is the eye chart shown in FIG. 8, which illustrates several overlaid data transition periods, consistent with an example embodiment of the invention. Here, several data signals making various transitions are overlaid, resulting in a pattern somewhat resembling an eye. The size and shape of the opening in the formed eye pattern, along with the variation in data signal lines that form the eye pattern, serve to illustrate the quality and variation in the data signal quality, and can provide a quick and useful characterization of a certain data channel operating at a given data rate.

The example data sampling methods discussed above become increasingly useful as the signal quality declines, such as is observed in the eye pattern of FIG. 8 or when a signal resembles signal 702 of FIG. 7 more than signal 701. Placing sampling points in a digital data receiver based on tracked locations of observed transition points can provide more reliable communication by sampling such a data signal at the point most likely to provide accurate data, improving the reliability and operating speed of a communications channel.

Such technology can be adapted to a wide variety of data receivers and other technologies, including serial and parallel communication, and to typical digital signals as well as other signals such as pulse amplitude modulated data. Although it is anticipated that adaptation of this technology into data receivers, integrated circuits, signal distribution networks, high performance computerized systems, and other such systems will improve their operating speed and reliability, the invention is not limited to these examples presented here. Even though specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A data communication receiver, comprising:
an interface, operable to receive at least one incoming data signal;
a transition point tracker, operable to track data transition points of the data signal; and
a data sampler, operable to sample the data signal at a desired sampling point between transition points.

2. The data communication receiver of claim 1, further comprising an interface operable to receive a clock signal.

3. The data communication receiver of claim 2, the transition point tracker operable to track a first transition point corresponding to the rising edge of the clock and a second transition point corresponding to the falling edge of the clock.

4. The data communication receiver of claim 1, the data sampler operable to compensate for at least one of an asymmetric clock signal and an asymmetric data signal by sampling the data at a desired point between first and second transition points.

5. The data communication receiver of claim 1, wherein the transition point tracker is further operable to derive an average transition point from the tracked transition points of the data signal.

6. The data communication receiver of claim 1, wherein the data sampler is further operable to sample the data signal at a desired sampling point between a prior observed transition point and a future predicted transition point, the future predicted transition point derived from the tracked data transition points.

7. A method of receiving digital data, comprising:
receiving at least one incoming data signal;
tracking data transition points of the data signal; and
sampling the data signal at a desired sampling point between transition points.

8. The method of receiving digital data of claim 7, further comprising receiving a clock signal.

9. The method of receiving digital data of claim 8, wherein tracking data transition points comprises tracking a first transition point corresponding to the rising edge of the clock and a second transition point corresponding to the falling edge of the clock.

10. The method of receiving digital data of claim 7, further comprising compensating for at least one of an asymmetric clock signal and an asymmetric data signal by sampling the data at a desired point between first and second transition points.

11. The method of receiving digital data of claim 7, further comprising deriving an average transition point from the tracked transition points of the data signal.

12. The method of receiving digital data of claim 7, wherein sampling the data signal comprises sampling the data signal at a desired sampling point between a prior observed transition point and a future predicted transition point, the future predicted transition point derived from the tracked data transition points.

13. A deserializer, comprising:
an input, operable to receive at least one incoming data signal;
a transition point tracker, operable to track data transition points of the incoming data signal;
a data sampler, operable to sample the incoming data signal at a desired sampling point between transition points; and
an output, operable to provide a deserialized digital signal.

14. The deserializer of claim 13, further comprising a clock interface operable to receive a clock signal, the transition point tracker operable to track a first transition point corresponding to the rising edge of the clock and a second transition point corresponding to the falling edge of the clock.

15. The deserializer of claim 13, wherein the transition point tracker is further operable to derive an average transition point from the tracked transition points of the data signal.

16. The deserializer of claim 13, wherein the data sampler is further operable to sample the data signal at a desired sampling point between a prior observed transition point and a future predicted transition point, the future predicted transition point derived from the tracked data transition points.

17. A computerized system, comprising:
a first integrated circuit, operable to send a data signal to a second integrated circuit;
an interface comprising a part of the second integrated circuit, the interface operable to receive at least one incoming data signal;
a transition point tracker comprising a part of the second integrated circuit, the transition point tracker operable to track data transition points of the data signal; and
a data sampler comprising a part of the second integrated circuit, the data sampler operable to sample the data signal at a desired sampling point between transition points.

18. The computerized system of claim 13, further comprising a clock interface comprising a part of the second integrated circuit, the clock interface operable to receive a clock signal, the transition point tracker operable to track a first transition point corresponding to the rising edge of the clock and a second transition point corresponding to the falling edge of the clock.

19. The computerized system of claim 13, wherein the transition point tracker is further operable to derive an average transition point from the tracked transition points of the data signal.

20. The computerized system of claim 13, wherein the data sampler is further operable to sample the data signal at a desired sampling point between a prior observed transition point and a future predicted transition point, the future predicted transition point derived from the tracked data transition points.
